(19) United States
(12) Patent Application Publication
(10) Pub. No.: US 2002/0180809 A1
(43) Pub. Date: Dec. 5, 2002

(54) Navigation in rendered three-dimensional spaces

(76) Inventors: John J. Light, Beaverton, OR (US); John D. Miller, Portland, OR (US); Doug L. Sorenson, Hillsboro, OR (US)

Correspondence Address: FISH & RICHARDSON, PC, 4350 LA JOLLA VILLAGE DRIVE, SUITE 500, SAN DIEGO, CA, 92122, US

(21) Appl. No.: 09/872,359

(22) Filed: May 31, 2001

(51) Int. Cl. G09G 5/00

(52) U.S. Cl. 345/852

(57) ABSTRACT

A three dimensional (3D) space is rendered to a user. The 3D space includes a 2D surface that is oblique to the display when rendered. An indicator constrained to the surface is used to determine the position of a user's intent.

### BACKGROUND

This invention relates to navigation in rendered three-dimensional (3D) spaces.

A 3D space can be displayed, for example, as a 2D rendering on a flat surface of a monitor or as a pair of stereo images, which can be viewed by a trained operator using stereo-glasses or a stereo-projection headpiece. Displayed 3D spaces can be used for simulations, such as flight simulators and fantasy games, design, and information visualization.

A displayed 3D space can provide an operating environment in which files, information, and applications are represented as objects located in the space. The WebBook and Web Forager environments used 3D space to organize and retrieve web pages (Card et al. “The WebBook and the Web Forager: An Information Workspace for the World-Wide Web,” in Proceedings of CHI'96 (New York, N.Y.) 1996 ACM Press 111-117). The STARLIGHT Information Visualization System provided an integrative information display environment in which the user's viewpoint could navigate in a 3D coordinate space (Risch et al. “The STARLIGHT Information Visualization System,” in Proceedings of IV '97 (London UK, August 1997) IEEE Computer Society 42-49). The Task Gallery is a 3D environment for document handling and task management (see, e.g., Robertson et al. “The Task Gallery: A 3D Window Manager,” in Proceedings of CHI '2000,” (The Hague NL, April 2000), ACM Press, 494-501).

The navigation of 3D space is facilitated by locating the 3D position of a user's interest using controls originally designed for navigation of 2D space. U.S. Pat. Nos. 5,689,628, and 5,608,850 describe methods of coupling a user's viewpoint in the 3D space to the transport of objects in the 3D space.

### DESCRIPTION OF DRAWINGS

FIGS. 1A and 1B are schematics of a system for operating Miramar, a simulated 3D environment for handling files and objects.

FIGS. 2A and 2B are a line drawing and a screenshot of a 2D projection of a 3D space.

FIGS. 3A, 3B and 3C are schematics of a 3D space.

FIG. 4 is a flow chart of a process for tracking a center of interest (COI).

FIG. 5 is a diagram of available directions of movement relative to a COI.

FIG. 6 is a flow chart of a method of selecting an object.

### DETAILED DESCRIPTION

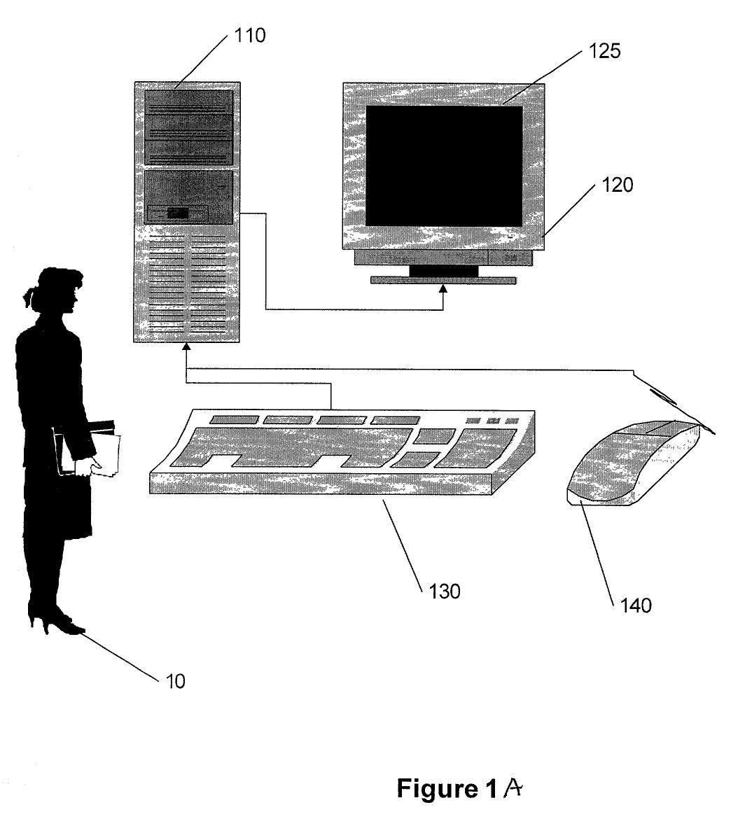

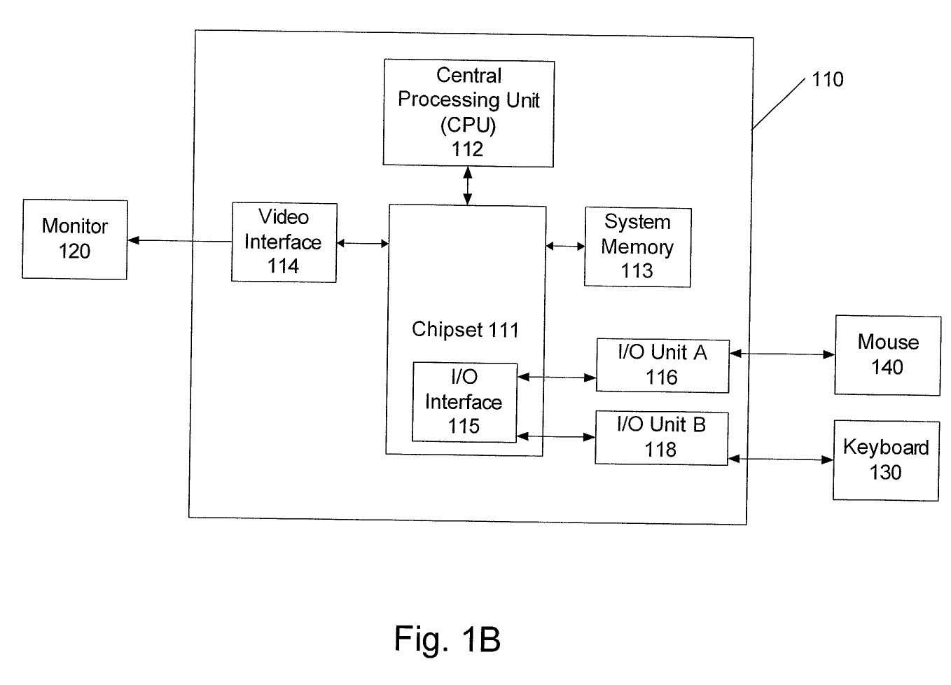

The so-called Miramar program is one implementation of aspects of the invention. Miramar simulates a 3D environment for file and object management. Referring to FIG. 1A, Miramar runs on a computer 110 that is interfaced with a monitor 120, a keyboard 130, and a mouse 140. As shown in FIG. 1B, the computer 110 can include a chipset 111 and central processing unit (CPU) 112 that operates Microsoft Windows® and that can compute 2D screen renderings of 3D space. The chipset 111 is connected to system memory 113. The computer 110 includes I/O interfaces 115, 116, and 118 for receiving user controls from the keyboard 130 and mouse 140.

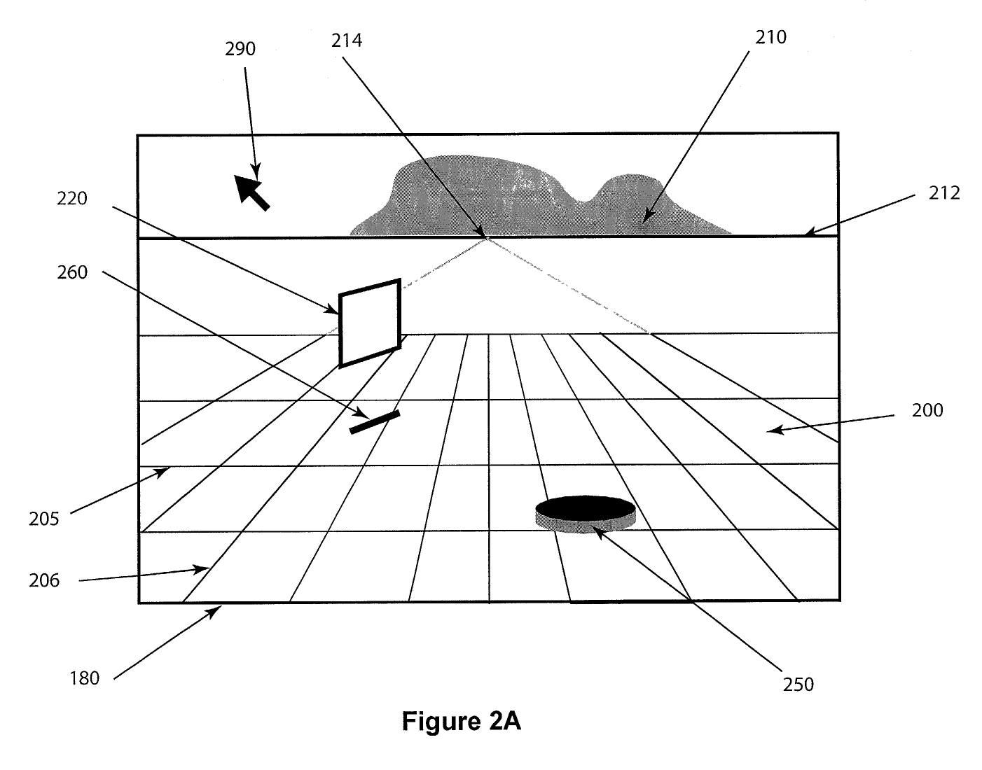

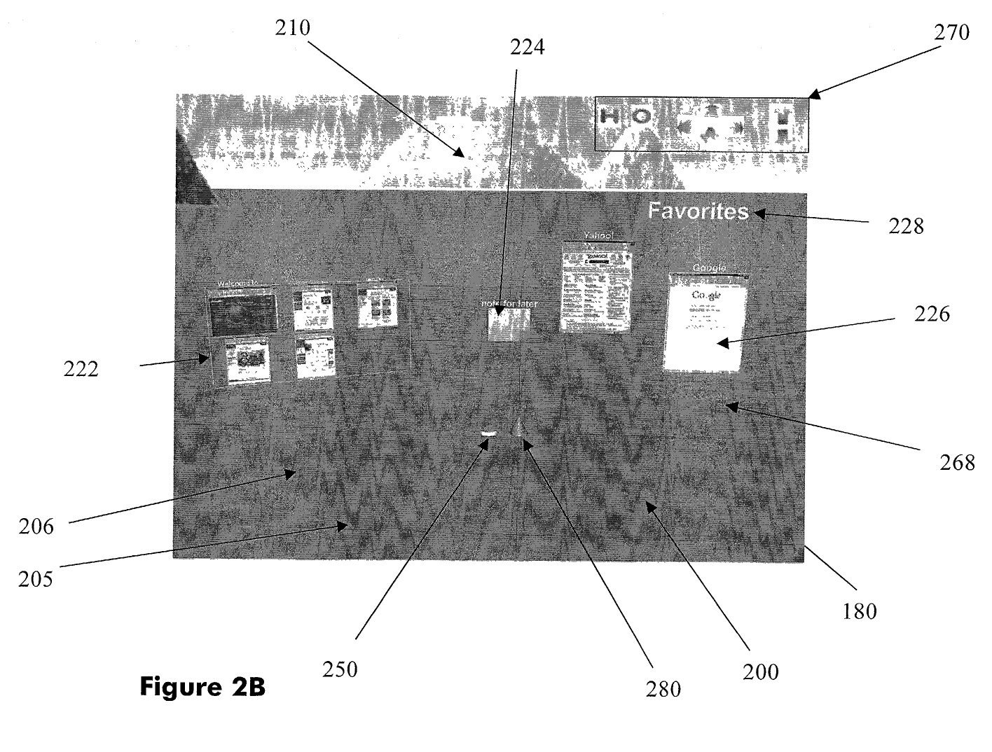

The computer 110 also includes an interface 114 for video output to the monitor 120. Referring also to FIGS. 2A and 2B?, the Miramar program generates a window 180 that is rendered on a 2D display area 125 of the monitor 120.

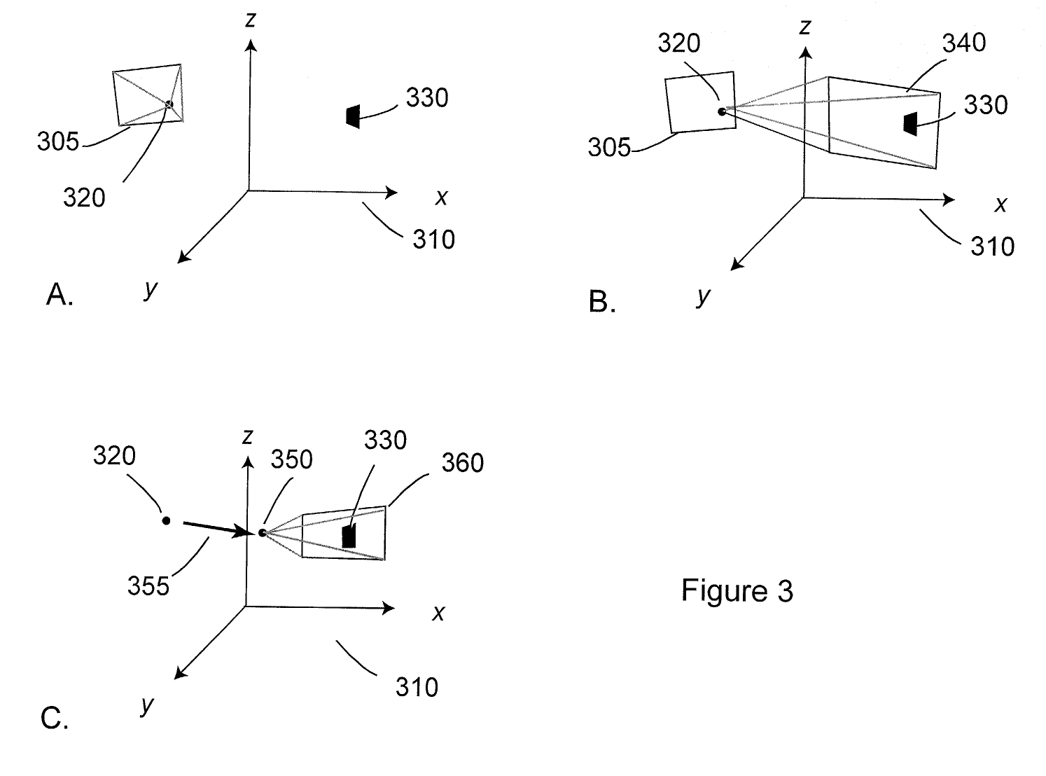

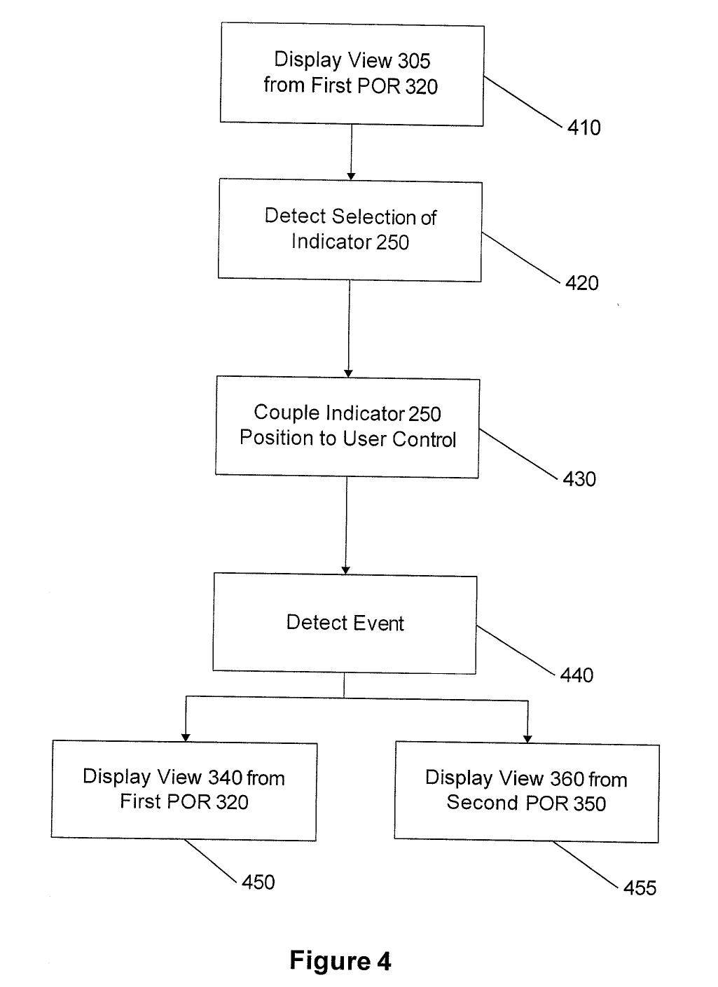

Referring also to the examples in FIGS. 3 and 4, the program displays 410 a first 2D projection 305 of a 3D space 310 to a user 10. The space 310 can include an object 330 that is located at a particular 3D location, and, in the example in FIG. 3A, is not visible in the first projection 305. The projection 305 is relative to a first point of reference (POR) 320. Information about the location of objects 330 in the 3D space 310 and the current POR 320 can be stored in the system memory 113.

Referring to the examples in FIGS. 2A and 2B, the projection of the 3D space 310 includes a planar surface 200, topographical elements 210, and objects 220, and the display also shows an indicator 250, and a cursor 290.

The topographical elements 210 can be selected by the user from a variety of scenes, such as mountains, fjords, canyons, and so forth. The topographical elements 210 provide a sense of scale and depth.

The planar surface, or “floor” 200 is rendered as a finite square grid with grid lines 205 and 206. For example, the grid lines 206 that project into the scene 180 are angled in perspective to meet at a vanishing point 214 on the horizon 212. The grid lines 205 and 206 enhance the user 10's sense of perspective. When projected, the floor 200 is generally oblique to the display area 180, except, of course, when the POR 320 is directly overhead.

The planar surface 200 can include landmarks such as a cone 280 that is positioned at its center. The cone provides a reference point for the user 10, called “home.”

The planar surface 200 features an indicator 250, which can be a squat cylinder or “puck,” for example, as depicted in FIG. 2B.

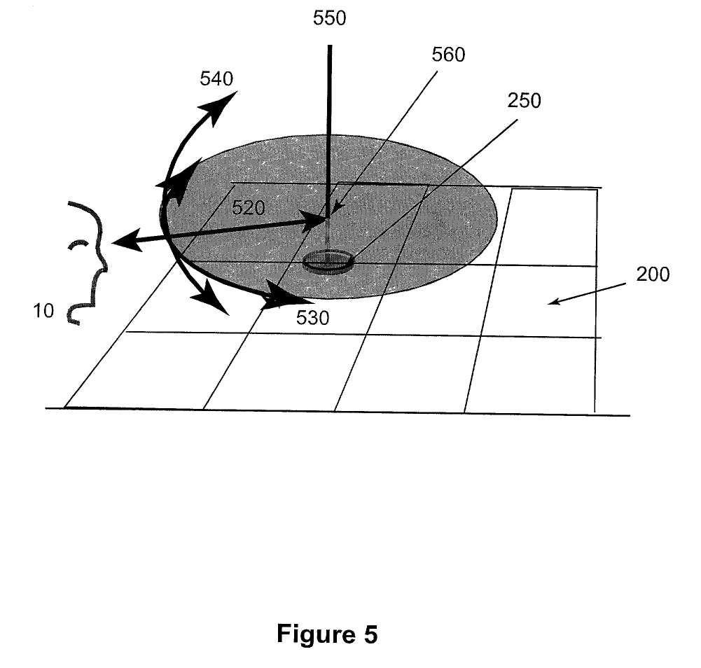

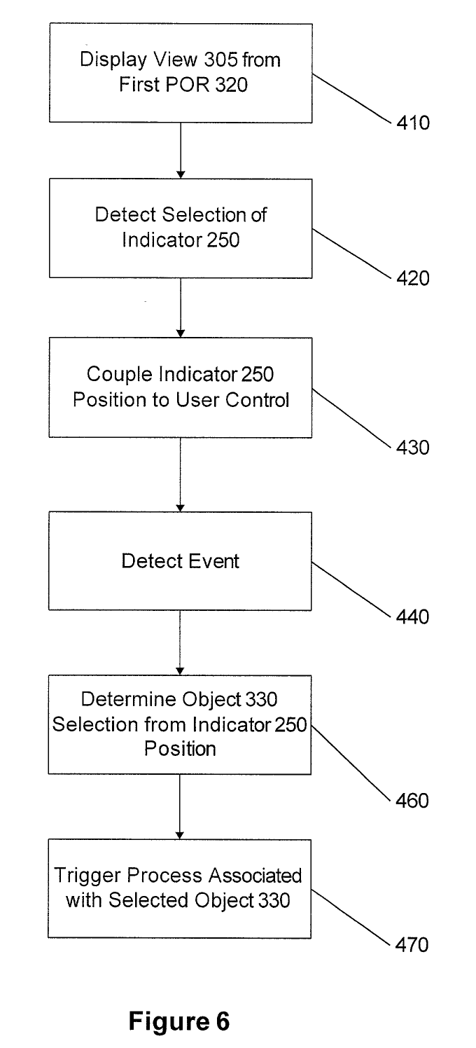

Referring also to FIG. 5, the indicator 250 provides a reference for the user 10 of the center of interest (COI) 560. The COI 560 is typically above the surface 200, and the indicator 250 is constrained to the surface 200 so as not to obscure the display of objects 220 in the scene 305. The user 10 can also control the indicator 250 as described below.

The 3D space 310 also includes objects 220, such as bulletin boards 222, notes 224, web pages 226, and text 228 that are rendered in positions above the surface 200. A “shadow” 260 of each object 220 is displayed on the surface 200 at a position that is directly underneath the object 220, such that a line between the shadow 260 and the object 220 is normal to the surface 200 in the 3D space 310. The shadows 260 orient the user 10 when navigating on the surface 200.

The user 10 can rely on visual recognition of the objects 220, topographic features 210, shadows 260, and gridlines 205 and 206 to orient himself in the coordinate space 310 and infer his point of reference 320.

At least five modes can be used to navigate in Miramar. Generally, navigation is controlled by the keyboard 130 and mouse 140. In some of the modes, the user can interface with at least two indicators, one being the indicator 250, the other being the cursor 290.

The first mode of operation enables the user 10 to reorient with respect to a COI 560, typically without moving the user's point of reference 320.

Referring to the example in FIGS. 3A and 3B, the program displays a first view 305 of the 3D space 310. The program allows the user 10 to select the indicator 250, e.g., using the cursor 290, which is controlled by the mouse 140. The selection of the indicator 250 is detected 420 and subsequently user controls (e.g., of the mouse 140) are coupled 430 to movement of the indicator 250 along the surface 200. For example, user-directed movement of the mouse 140 along each of the two axes on a table is translated into scaled movement of the indicator 250 on the 2D plane 200.

When the program detects 440 an event such as release of a mouse button, the program alters the window 180 to display a second view 340 based on the new position of the indicator 250. Other events that can be detected include: an arrest of movement of the indicator 250; or movement of the indicator 250 to a margin of the first view 305 or outside the first view 305. The latter event can be used to enable the user 10 to pan through the space 310.

The alteration to the rendering of window 180 can be a rotation about the POR 320, i.e., the location of the user's position in 3D space 310 is the same, but the angle of the user's view of the 3D coordinate space 310 is altered from the first view 305 to a second view 340. Typically, the second view 340 locates the COI 560 in the center of the 2D display area 180. The level of the horizon 212 can also be adjusted so that the COI 560 is visible.

The alteration of the window 180 from the original view 305 to the second view 340 can be rendered in a seemless manner. For example, the program may display a sequence of views with respect to time that simulate to the user 10 a rotation and/or tilting of his head with respect to the space 310.

In a second mode of navigation, the user 10 moves his POR 320 in any of three dimensions with respect to the COI 560, as depicted in FIG. 5. The user 10 uses the cursor 290 coupled to the mouse 140 to navigate. The cursor is used to select directional buttons on the control panel 270. Keyboard 130 strokes (e.g., of arrow keys) also function to receive user moves.

Left and right commands rotate the user's POR 320 in a circular orbit 530 around the COI 560. The POR 320 is moved at a constant angular velocity about the axis 550 at the COI 560. The angular velocity used is independent of distance from the indicator 250. The circular trajectory around the COI 560 allows the user 10 to see all facets of an object at the COI 560.

Up and down commands can be used to increase and decrease the inclination 540 of the user's POR 320 with the respect to the COI 560. Movements in this direction can also be made in an orbital path 540 with a constant angular velocity.

Zoom in and out commands can be used to alter the distance 520 between the user's POR 320 and the COI 560. These movements can be made with an effective velocity that is proportional to the distance. Typically, a standard increment, e.g., for a keyboard command for zoom movements, is a distance that is approximately 6% of the distance from the current viewpoint to the COI 560. Such scaling prevents the user 10 from advancing past the COI 560.

In a third mode of navigation, the user 10 manipulates 430 the indicator 250 to specify a COI 560. Then in response to an event 440, the program displays a second view 360 from a second POR 350, as illustrated in FIG. 3C. For example, the event can be release or double-clicking of a mouse button.

The second view 360 can include an alteration that enhances the representation of the COI 560. For example, the second position 350 can provide a second view 360 that enlarges the COI 560 and/or provides a view of a primary facet of the COI 560.

The program can again provide an apparently seemless transition from the first view 305 or 340 to the second view 360 by displaying a sequence of views, such that the user perceives he is flying on a trajectory 355 through the 3D space 310 from the original position 320 to the second position 350.

In a fourth mode of navigation, the user 10 again manipulates 430 the indicator 250 to specify a COI 560. In response to an event 440, such as a double mouse click, the program identifies an object 330 based on the position of the indicator 250. Typically, the identified object 330 is the object that is located directly above the indicator 250. Otherwise, the object that is closest to the indicator 250 can be used. The program then triggers 470 a process that is associated with the selected object 330.

In Miramar, many objects represent links to files. The triggered process can include activating an application appropriate for the linked file to open or read the linked file. Other objects can represent web links, which when selected open up the corresponding web site using the default web browser.

The use of the indicator 250 to specify an object is particularly cogent when objects 220 are partially or completely overlapping in a particular rendering of the 3D space.

In a fifth mode of navigation, the user 10 selects an object or point of interest in the 3D space 310 using the cursor 290. The program identifies the coordinates of the cursor 290 position, and then determines if an object 330 is displayed at that position in the current rendering of the 3D space 310. If an object is present, it is designated the selected object 330. Otherwise, the position is designated as a selected point. In addition, the user can select an object of interest using a text menu that lists available objects by their identifiers.

After an object or point is selected, the indicator 250 is repositioned automatically underneath the selected object 330 or point to confirm to the user the new COI 560 defined by the selection event. If no object is present or visible at the selected point, the indicator 250 can serve as a surrogate for an object to the user 10.

The program includes other optional features that can be activated to assist the user in selecting objects 220 with the indicator 250. For example, the indicator 250 can be rendered with a projection that extends normal to the surface 200 to the height of an object located above the indicator 250. In still other implementations, an object located above the indicator is rendered differently, e.g., highlighted with a color or assigned a new attribute (e.g., “flashing,” and so forth).

Other implementations are also within the scope of the claims. For example, although the Miramar program provides a 3D space for managing files and information, the featured indicator 250 can be used in any program that renders a projection of 3D space. Other programs can include computer-assisted design applications, defense and security applications, cartographic applications, mathematical modeling applications, games, and simulators.

In some implementations, two surfaces 200 are used that are normal to each other. One surface is located in the x-y plane, whereas the other is in the y-z plane. Each surface has an indicator 250 linked to the position of a COI such that a line between each indicator and the COI is normal to its respective surface. Thus, the user 10 can readily perceive the position of the COI 560 in 3D space 310 as rendered in a 2D projection.

In other implementations, the 2D surface 200 is not planar, e.g., it is concave or convex. Positions on the 2D surface are nevertheless addressable using two coordinates, e.g., Cartesian or non-Cartesian coordinates.

The monitor 120, mouse 140, and keyboard 130 can be replaced by other user interfaces such as stereo headpieces, joysticks, and so forth.

The techniques described here are not limited to any particular hardware or software configuration; they may find applicability in any computing or processing environment. The techniques may be implemented in hardware, software, or a combination of the two. The techniques may be implemented in programs executing on programmable machines such as mobile or stationary computers, personal digital assistants, and similar devices that each include a processor, a storage medium readable by the processor, at least one input device, and a display.

Each program may be implemented in a high-level procedural or object oriented programming language to communicate with a machine system. However, the programs can be implemented in assembly or machine language, if desired. In any case, the language may be a compiled or interpreted language.

Each such program may be stored on a storage medium or device, e.g., compact disc read only memory (CD-ROM), hard disk, magnetic diskette, or similar medium or device, that is readable by a general or special purpose programmable machine for configuring and operating the machine when the storage medium or device is read by the computer to perform the procedures described in this document. The system may also be implemented as a machine-readable storage medium, configured with a program, where the storage medium so configured causes a machine to operate in a specific and predefined manner.

What is claimed is:

1. A method comprising
enabling a user to move an indicator that is constrained to a 2D surface rendered in a projection of 3D space on a display, the rendered 2D surface appearing to lie obliquely to the display; and
effecting an action in response to the user's control of the indicator.

2. The method of claim 1 further comprising enabling the user to move a second indicator on the display, the second indicator not being constrained to the 2D surface.

3. The method of claim 1 in which the 2D surface comprises a plane.

4. The method of claim 1 in which the display comprises rendered objects each having a position in the 3D space.

5. The method of claim 4 in which each object corresponds to a file associated with a file-handling application and the action comprises triggering the file-handling application to open the file.

6. The method of claim 4 in which the display further comprises object markers, each object marker corresponding to an object and being rendered on the 2D surface at a position associated with the location of the object.

7. The method of claim 1 in which the action comprises altering the projection of the 3D space to indicate motion to the user.

8. The method of claim 1 in which the action comprises altering the projection of the 3D space to indicate to the user a change in viewpoint in the 3D space along a circular path, the center of which is on an axis perpendicular to the 2D surface at the position of the indicator.

9. The method of claim 1 in which the display comprises rendered topographic elements that orient the user's perception of the 3D space.

10. A method comprising:
rendering a first view of a 3D space from a first reference point, the 3D space comprising objects, a 2D surface, and a first indicator on the 2D surface;
detecting a user's control of a second indicator that is moveable in the first view; and
rendering a second view of the 3D space as a function of the user's control of the second indicator.

11. The method of claim 10 in which movement of the second indicator in the first view is coupled to movement of the first indicator on the 2D surface.

12. The method of claim 11 in which the first indicator is located at a predetermined position in the first view, and the second view restores the first indicator to the predetermined position.

13. The method of claim 10 in which the second indicator specifies a selected point in the first view of the 3D space and the second view relocates the first indicator to a position on the 2D surface that is associated with the selected point.

14. The method of claim 13 in which the position associated with the selected point is on the 2D surface and is intersected by a line normal to the 2D surface through the selected point.

15. The method of claim 10 or 14 in which the second view is from a second reference point that is closer to the first indicator than the first reference point.

16. The method of claim 10 in which the second view is from the first reference point.

17. A method comprising:
displaying a projection of a 3D space that comprises a 2D surface, a user-selected object, and an indicator positioned on the surface at a position associated with the user-selected object, the projection simulating a user's perspective from a first viewpoint;
receiving a directional cue from the user with respect to the indicator;
determining a second viewpoint based on the directional cue;
displaying a sequence of projections of the 3D space and a projection of the second viewpoint, the sequence simulating motion from the first viewpoint to the second viewpoint.

18. The method of claim 17 in which the indicator is positioned near or at a point on the surface through which an axis normal to the surface intersects the user-selected object.

19. The method of claim 17 in which the motion comprises motion that circumnavigates the user-selected object.

20. The method of claim 17 or 19 in which the second viewpoint includes the user-selected object.

21. The method of claim 17 or 19 in which the second viewpoint includes the user-selected object at the same relative position in the projection of the second viewpoint as the position of the user-selected object in the projection of the first viewpoint.

22. A system comprising:
a display unit that displays a rendering of a 3D space that comprises a 2D surface that appears to be oblique to the display unit;
a memory unit that stores information about objects located in the 3D coordinate space and a user's viewpoint;
a user interface configured to receive user controls for moving an indicator on the 2D surface; and
a processor configured to
compute a rendering of the 3D space from the stored information;
couple the user controls to movement of the indicator; and
trigger a process based on location of the indicator.

23. The method of claim 22 in which the process comprises computing a second rendering of the 3D space, the second rendering restoring the indicator to a preferred position relative to display unit.

24. The method of claim 23 in which the process comprises selecting an object in the 3D space that is located near an axis that is normal to the 2D surface and that intersects the indicator.

25. An article comprising a machine-readable medium that stores machine-executable instructions, the instructions causing a machine to:
render a first projection of a 3D space from a first viewpoint, the space comprising objects, a 2D surface, and a first indicator located on the 2D surface;
detect a user's control of a second indicator that is moveable in the first projection; and
render a second projection of the 3D space as a function of the user's control of the second indicator.

26. The article of claim 25 in which movement of the first indicator on the 2D surface is coupled to the user's control of the second indicator.

27. The article of claim 26 in which the first indicator is located a preferred position relative to the frame of the first projection, and the second view restores first indicator to the preferred position.

28. The article of claim 25 in which second projection enhances representation of an object located near a line that intersects the first indicator and is perpendicular to the 2D surface.

29. The article of claim 25 in which the user's control of the second indicator specifies a selected object from the objects in the space, and the second projection comprises the first indicator located on the 2D surface at a position associated with the selected object.
